(19) United States
(12) Patent Application Publication
(10) Pub. No.: US 2023/0321744 A1
(43) Pub. Date: Oct. 12, 2023

(54) DEVICE FOR ARC WELDING AND METHOD OF IMPLEMENTING THE SAME

(71) Applicant: Shimon VAINER, Be'er Sheva (IL)

(72) Inventor: Shimon VAINER, Be'er Sheva (IL)

(21) Appl. No.: 17/722,373

(22) Filed: Apr. 17, 2022

Related U.S. Application Data
(60) Provisional application No. 63/329,529, filed on Apr. 11, 2022.

(51) Int. Cl. B23K 9/067

(52) U.S. Cl. CPC B23K 9/0672

(57) ABSTRACT

Methods and devices for welding arc ignition and, more particularly, to ionizing an area of a contact between an electrode and articles to be welded. Methods and devices for igniting an arc discharge and welding.

### FIELD OF THE INVENTION

The present invention relates to welding arc ignition and, more particularly, to ionizing an area of a contact between an electrode and articles to be welded.

### BACKGROUND OF THE INVENTION

WO2014041050 discloses an ignition system having: a high voltage generator, in particular a step-up transformer, with a primary side and a secondary side; an electrical energy source which can be connected to the primary side; and a spark gap which is designed to carry a current transferred by the step-up transformer to the secondary side. The step-up transformer has a bypass for transferring electrical energy from the electrical energy source to the secondary side. The bypass is designed to support a diminishing electrical signal in the secondary coil of the high-voltage generator after a predefined time or once a predefined current intensity of the current has been reached. Use of high-voltage discharges for igniting an arc is dangerous for a welder. In addition, this kind of the ignition system interferes in operation of radio and TV and other electronic devices. Nowadays, the ignition systems of this kind are prohibited for use.

U.S. Pat. No. 6,156,999 discloses a method and a device for welding arc ignition of an arc welding apparatus providing a reduced level of high frequency disturbances. A welding electrode and a workpiece are connected with a welding power source and to at least two additional high voltage power sources. A short a periodic high voltage pulse is transmitted from the first high voltage power source to a gap present between the welding electrode and the workpiece, to break down the air present between the welding electrode and the workpiece, and to create a current conducting duct therebetween. The current output of the high voltage power source is restricted in amplitude and rate of rise. The short non-periodic high voltage pulse is superimposed by another, long, high voltage pulse from the second high voltage power source. The long pulse has a current rate of rise not exceeding that of the short pulse, and the open circuit voltage of the second high voltage power source is lower than that of the first high voltage power source. A stretched pulse appears, and the duration of the current discharge increases. The current conducting duct is heated, its electric resistance decreases and an arc is ignited. When the voltage in the current conducting duct decreases to a value less than that of the open circuit of the welding power source, the current starts flowing through the welding electrode and arc to the workpiece, resulting in a welding arc burning from the welding power source.

In the course of ignition an arc discharge, atmospheric air or other gas is ionized in proximity of a contact point of an electrode and articles to be welded by providing a predetermined amount of energy. In a contactless type of ignition, energy is input in a pulsed manner down to a breakdown of a small gap. The ignition process is characterized by high energy input rate and emitting electromagnetic radiation of a wide spectrum.

Therefore, there is a long-felt and unmet need for providing a smooth high-frequency energy at a stage of arc ignition and during the welding process for stabilization the arc discharge and improving welding quality. The input of this energy can be not only at the beginning of welding, but also continuously during the welding process what affects the quality of AC and DC welding.

### SUMMARY OF THE INVENTION

It is hence one object of the invention to disclose method of igniting an arc discharge and welding thereby. The aforesaid method comprise steps of: (a) providing a device for igniting an arc discharge and welding thereby; said device comprising: (i) a power supply further comprising a power transformer; (ii) igniting and stabilizing means further comprising connected in series a high-frequency generator and a resonant circuit (iii)) output terminals connectable to an electrode and a welding stand; said power supply and said ignition means are connectable to said output terminals in parallel manner; (iv) a control unit preprogrammed to ignite said arc discharge and maintain stability of said arc discharge during said welding; (b) placing articles to be welded onto said welding stand; (c) connecting said electrode and welding stand to said output terminals; (d) contacting said electrode with at least one of said articles to be welded; (e) applying a high-frequency voltage generated by said generator to said electrode; (f) applying a welding voltage from said power transformer to said electrode.

It is a core purpose of the present invention to provide said step of applying a welding voltage performed with a predetermined delay relative to said step of applying a high-frequency voltage.

Another object of the invention is to disclose said step of providing said device for igniting an arc discharge and welding thereby comprises providing said power supply and igniting and stabilizing means further comprising a power rectifier and a high-frequency rectifier, respectively.

A further object of the invention is to disclose said power transformer having an open-circuit output voltage ranging between 30 and 32V.

A further object of the invention is to disclose said high-frequency voltage which is a rectangular voltage ranging between 40 and 60V at frequency ranging between 35 and 40 kHz and power ranging between 250 and 300 W.

A further object of the invention is to disclose said predetermined delay ranging between 1 and 2 sec.

A further object of the invention is to disclose a device for igniting an arc discharge and welding thereby. The aforesaid device comprises: (a) a power supply further comprising a power transformer; (b) igniting and stabilizing means further comprising connected in series a high-frequency generator and a resonant circuit; (c) output terminals connectable to an electrode and a welding stand; said power supply and said ignition means are connectable to said output terminals in parallel manner; (d) a control unit preprogrammed to ignite said arc discharge and maintain stability of said arc discharge during said welding.

Said control unit is preprogrammed to apply said welding voltage from said power transformer to said electrode with a predetermined delay relative to applying a welding voltage from said power transformer to said electrode.

A further object of the invention is to disclose said power supply and igniting and stabilizing means comprising a power rectifier and a high-frequency rectifier, respectively.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIGS. 1a and 1b are electrical circuit diagrams of AC and DC devices for arc welding, respectively;

FIG. 2 is a schematic diagram of a device for arc welding; and

FIGS. 3a and 3b are photographs of welds made by an AC device for arc welding according to the present invention and a conventional AC device for arc welding, respectively.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a device for arc welding and a method of implementing the same.

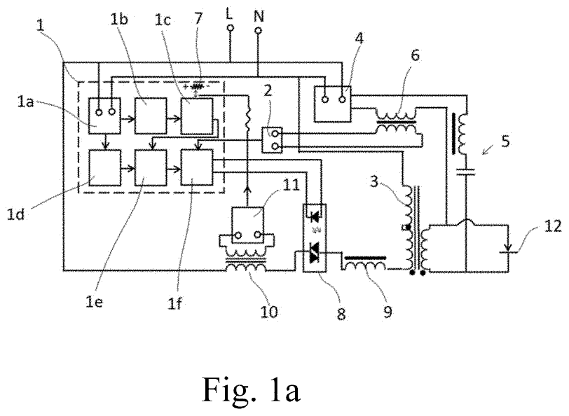

Reference is now made to FIG. 1a presenting an electrical circuit diagram of an AC device for arc welding. Control unit 1 further comprises:
1. pulse shaper 1a providing synchronizing pulses at it-tuple phase points corresponding to zero value of mains voltage;
2. shaper 1b providing a synchronized sawtooth voltage;
3. shaper 1c providing rectangular pulses having synchronized leading pulse edges and tailing edges corresponding to a phase point when the sawtooth voltage achieves a preset voltage controlled by potentiometer 7;
4. 3 kHz pulse generator 1d;
5. logic NAND gate 1e providing bursts of pulses; and
6. amplifier 1f configured for amplifying the pulsed provided by logic NAND gate 1e.

The amplified pulses are transmitted to a gate electrode of triode for alternating current (triac) 8. It should be noted that amplifier 1f is controlled by timer 2 which is configured for delaying energization of power transformer 3 with an open-circuit output voltage of 30-32 V.

High-frequency generator 4 produces a rectangular voltage with a frequency of 35-40 kHz, 40-60V with an amplitude and a power of 250-300 W. This voltage is fed through a resonant circuit 5 such that the sinusoidal voltage component of the same frequency is provided to the output of a power transformer 3.

The primary winding of power transformer 3 is connected to mains via triac 8, filter 9 with ferrite core and current meter 10. Filter 9 protects triac 8 from high frequency voltage which occurs in the primary winding. To correct the external characteristics of the device, negative feedback from welding current is used. The feedback voltage is formed by the current meter 10 of the primary winding of the transformer and feedback unit 11.

When the electrode touches an article, the high-frequency voltage creates a current in the area of contact. The current detected by current meter 10 activates timer 2 with a preset delay. Heating of the electric contact area is required for ionization of the gases in proximity of it and defined by the preset time delay ranging between 1 and 2 sec. Finally, a welding arc is ignited after energizing power transformer 3 by timer 2.

Reference is now made to FIG. 1b presenting an electrical circuit diagram of a DC device for arc welding. Numerals 14 and 15 refer to rectifiers connected to outputs of power transformer 3 and high frequency generator 4.

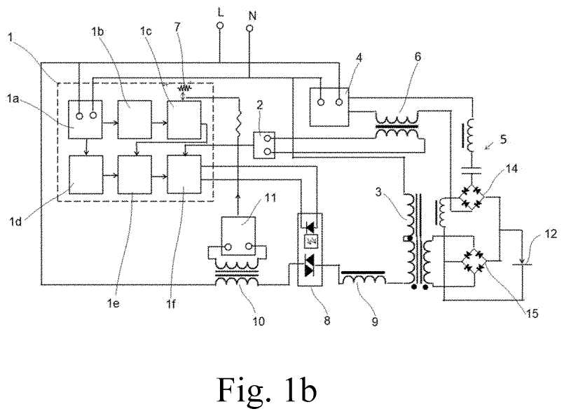

Reference is now made to FIG. 2 presenting block diagram of a device for DC welding. The output of generator 4 is connected to high-frequency rectifier 14 and resonant circuit 5. Power transformer 3 is connected to rectifier 15. The outputs of rectifiers 14 and 15 are connected in parallel via inductor 16 to welding stand 12.

It should be noted that resonant circuit 5 allows parallel connection of the high-frequency and power supply circuits and prevents the welding device of the present invention from a shortcut. The aforesaid parallel connection results in summing of amplitudes of high-frequency and mains voltages without loses in the power output. The coil of resonant circuit 5 is made of an individually insulated multiple-core cable in order to avoid overheating the coil due to the skin effect caused by the high-frequency current in the coil. The resonant frequency of each resonant circuit 5 is adjusted in manufacturing by positioning a core within the coil in order to match the circuit resonant frequency and the frequency of generator 4.

Inductor 16 is provided with a ferrite core serving for accumulation of energy during welding and an ignition voltage rise in case of open welding circuit. When a minus on the electrode, quality of welding does not differ from welding on alternating current. Transformer 3 and rectifier 15 can be replaced with any DC source.

According to one embodiment of the present invention, power transformer 3 has transformation ratio equal to 7.5 in order to obtain on output voltage not higher than 30-32V. Energy is supplied to welding stand 12 from power transformer 3 and generator 4. Combining high- and low-frequency voltages at the output of power transformer 3 allows decrease in turning number the secondary winding of transformer 3. Reliable arc ignition is maintained because:
1 The total open circuit voltage at the output of power transformer 3 reaches 80 volts.
2. Power transformer is switched on by a timer with a delay of 1-1.5 sec. after bringing into contact the electrode and the article to be welded which results in heating a surrounding area and creating a required ionized zone therearound.
3. The skin effect created by the high-frequency current at the contact point causes rise in current density within the arc discharge and, as the result, additional increase in temperature and ionization in the surrounding area. The ionized gases from the flux located at the end of the electrode take an active part in welding process.

Therefore, by the moment energizing power transformer 3, optimal conditions required for ignition of arc high-frequency discharge are created. The reliability of the ignition depends on the current produced by the generator, time delay provided by timer 2 and thermal conductivity of welded metal. It was experimentally shown that welding current of 10 A and time delay of 1 sec provide a failure-free ignition of the arc discharge on samples of various types of steel with a thickness of 25 mm or more. It should be emphasized that the high-frequency current is free of steep edges and spark discharges such that electromagnetic interference is minimized.

It should be noted that there is no need for powerful reactive elements for suppressing the short-circuit current at the start of welding because power transformer 3 is turned on with time delay when the welding area is heated and created in the welding area is characterized by high electrical resistance and limits the welding current at the moment of arc ignition.

The arc discharge combined with high-frequency plasma is characterized by increased temperature and energy concentration, enhanced stability, as a result, improved quality of welding. In particular, roughness of welded surfaces is significantly reduced.

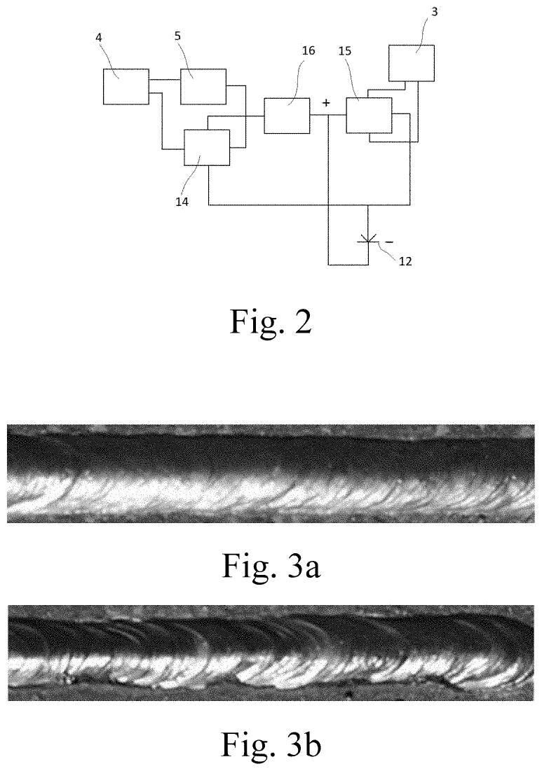

Reference is now made to FIGS. 3a and 3b showing experimental welds made at alternating current be means of a combined high-frequency plasma-arc welding and by a standard arc welding.

In the cases of short arc welding or electrode immersion in a bath, high-frequency plasma prevents the electrodes from sticking even at low currents. The present invention enables producing high quality welds in thin metal articles at low currents. Thus, there is no need for anti-stick systems used in welding inverters (see, for example U.S. Ser. No. 10/967,451).
3. Turning on the transformer takes place with a delay of 1-1.5 seconds after the timer is triggered, which is switched on when appearance the current produced by the generator, when the metal touches the electrode.
4. At the specified frequency of the generator, a significant skin effect occurs and causes an increase in the current density on the surface of the end of the electrode and the adjacent surface of the product. The skin effect accelerates the temperature rise at the point of contact and the formation of high-frequency plasma. Plasma formation is also facilitated by emission of ionized gases from the molten flux located at the end of the electrode.
5. Turning on transformer 3 provides an arc with a two-frequency plasma, specifically, at a mains frequency and at a frequency of generator.
6. High-frequency plasma makes the arc elastic. The arc does not break when the electrode is breaks off by 15=20 mm at a low voltage of the transformer.
7. High-frequency plasma increases arc stability and concentration by reducing random variations in weld width and height, making the weld surface smoother. This improves weld quality. The presence of this plasma also reduces spatter.
8. The device eliminates the no-load current of the transformer, since it turns on after the delay required for the ignition of the arc.
9. Welding with additional high-frequency plasma prevents the electrode from sticking at any given welding current, which allows welding thin sheets When welding, the electrode can move along the surface of the bath and welding can be performed with the electrode immersed in the bath. Thus, in transformer sources, the need for special anti-stick system is not required.
10. Despite there are no power reactive elements in the device, when the transformer is turned on, a large short-circuit current does not arise, since there is already a section in the circuit with a high temperature and an increased resistance of the ionized zone
11. For direct current welding, additional elements are introduced into the device: a rectifier connected to transformer and calculated for the maximum welding current, the input of which is connected to the output of the transformer and a rectifier for a current of 20 A, the input of which is connected to the output of the resonant circuit and to the generator. The outputs of the rectifiers are connected in parallel through an inductor. Outputs of them connected to electrode. Inductor used for accumulation of energy during welding and an increase in the ignition voltage when the electrode is torn off at the end the weld.
12. The proposed method and device expands the technological capabilities of transformer sources and improves the quality of welding of steel structures on alternating current, which is not inferior to welding of similar structures on direct current. In addition, the proposed device can significantly simplify welding transformers by replacing on power transformers with cos φ close to 1, what should be especially interest to companies producing at welding transformers.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method of igniting an arc discharge and welding thereby; said method comprising steps of:
a. providing a device for igniting an arc discharge and welding thereby; said device comprising:
i. a power supply further comprising a power transformer;
ii. igniting and stabilizing means further comprising connected in series a high-frequency generator and a resonant circuit
b. output terminals connectable to an electrode and a welding stand; said power supply and said ignition means are connectable to said output terminals in parallel manner;
c. a control unit preprogrammed to ignite said arc discharge and maintain stability of said arc discharge during said welding;
b. placing articles to be welded onto said welding stand;
c. connecting said electrode and welding stand to said output terminals;
d. contacting said electrode with at least one of said articles to be welded;
e. applying a high-frequency voltage generated by said generator to said electrode;
f. applying a welding voltage from said power transformer to said electrode;
wherein said step of applying a welding voltage is performed with a predetermined delay relative to said step of applying a high-frequency voltage.

2. The method according to claim 1, wherein said step of providing said device for igniting an arc discharge and welding thereby comprises providing said power supply and igniting and stabilizing means further comprising a power rectifier and a high-frequency rectifier, respectively.

3. The method according to claim 1, wherein said power transformer has an open-circuit output voltage ranging between 30 and 32V.

4. The method according to claim 1, wherein said high-frequency voltage is a rectangular voltage ranging between 40 and 60V at frequency ranging between 35 and 40 kHz and power ranging between 250 and 300 W.

5. The method according to claim 1, wherein said predetermined delay is in a range between 1 and 2 sec.

6. A device for igniting an arc discharge and welding thereby; said device comprising:
a. a power supply further comprising a power transformer
b. igniting and stabilizing means further comprising connected in series a high-frequency generator and a resonant circuit;
c. output terminals connectable to an electrode and a welding stand; said power supply and said ignition means are connectable to said output terminals in parallel manner;
d. a control unit preprogrammed to ignite said arc discharge and maintain stability of said arc discharge during said welding;
wherein said control unit is preprogrammed to apply said welding voltage from said power transformer to said electrode with a predetermined delay relative to applying a welding voltage from said power transformer to said electrode.

7. The device according to claim 6, wherein said power supply and igniting and stabilizing means comprising a power rectifier and a high-frequency rectifier, respectively.

8. The device according to claim 6, wherein said power transformer has an open-circuit output voltage ranging between 30 and 32V.

9. The device according to claim 6, wherein said high-frequency voltage is a rectangular voltage ranging between 40 and 60V at frequency ranging between 35 and 40 kHz and power ranging between 250 and 300 W.

10. The device according to claim 6, wherein said predetermined delay is in a range between 1 and 2 sec.
